(19) United States
(12) Patent Application Publication
(10) Pub. No.: US 2026/0307720 A1
(43) Pub. Date: Oct. 8, 2026

(54) JOINT STRUCTURE OF VEHICLE BODY

(71) Applicants: Hyundai Motor Company, Seoul (KR); Kia Corporation, Seoul (KR)

(72) Inventors: Hyuncheol Yun, Hwaseong-si (KR); Jiae Yong, Hwaseong-si (KR); Jejoon Lee, Hwaseong-si (KR); Chulhee Heo, Hwaseong-si (KR); Seung Min Jeong, Hwaseong-si (KR)

(21) Appl. No.: 19/551,195

(22) Filed: Feb. 26, 2026

(30) Foreign Application Priority Data
Apr. 2, 2025 (KR) 10-2025-0042538
Oct. 29, 2025 (KR) 10-2025-0158785

(51) Int. Cl. B62D 21/15; B60G 11/18; B62D 25/08; B62D 27/06; B62D 33/02

(52) U.S. Cl. CPC B62D 21/152; B60G 11/183; B62D 25/088; B62D 27/065; B62D 33/02; B60G 2206/20

(57) ABSTRACT

A vehicle body joint structure of a vehicle, wherein the vehicle includes a monocoque platform including a cabin portion, and a suspension mounting portion having a step difference with respect to the monocoque platform and configured to mount a suspension on the suspension mounting portion, and the vehicle body joint structure may include a center leveling member disposed to extend in a width direction of the vehicle in an upper central portion of the monocoque platform, and a side leveling member connected to a side end of the center leveling member and disposed to extend in a length direction of the vehicle, wherein an upper surface of the center leveling member and an upper surface of the side leveling member are disposed to have the same height as an upper surface height of the suspension mounting portion.

### CROSS-REFERENCE TO RELATED APPLICATIONS

This application claims priority to and the benefit of Korean Patent Application No. 10-2025-0042538 filed with the Korean Intellectual Property Office on Apr. 2, 2025, and Korean Patent Application No. 10-2025-0158785 filed with the Korean Intellectual Property Office on Oct. 29, 2025, the entire contents of which are incorporated herein by reference.

### TECHNICAL FIELD

The present disclosure relates to a vehicle body joint structure.

### BACKGROUND

Recently, the vehicle industry has been introducing a new concept of future mobility vision for realizing a dynamic, human-centered future city. One of these future mobility solutions is the purpose built vehicle (PBV), which serves as a purpose-based mobility solution.

An example of a PBV vehicle is an electric vehicle (EV)-based environment-friendly mobility vehicle. A vehicle body of the PBV vehicle may be formed of a cabin portion, which becomes a space of an occupant, and a special equipment part where a cargo is loaded.

However, as shown in FIG. 1, for example, there is an excessive step difference “d” between a special equipment part 2 where a coupled torsion beam axle (CTBA) is mounted and the cabin portion manufactured with a low-floor monocoque platform 1, where the suspension is mounted, and the step portion is likely to bend due to the impact in the event of a rear collision.

Therefore, there is a need to improve the rear collision performance of a vehicle formed of a monocoque platform and a suspension mounting portion on which the suspension is mounted.

### SUMMARY

The present disclosure relates to a vehicle body joint structure, and more particularly, it relates to a vehicle body joint structure with an improved load path to disperse an impact load when a rear collision occurs in a monocoque body type vehicle.

Therefore, to solve the above problem, some embodiments of the present disclosure may provide a vehicle body joint structure that can mitigate the impact caused by a rear collision by removing a step difference between a monocoque platform and a suspension mounting portion in a monocoque body type vehicle.

A vehicle body joint structure according to an embodiment of the present disclosure may be a vehicle body joint structure for a vehicle formed of a monocoque platform including a cabin portion and a suspension mounting portion forming a step difference with respect to the monocoque platform and on which a suspension is mounted, and may include: a center leveling member disposed to extend in a direction vertical to a length direction of the vehicle in an upper central portion of the monocoque platform; and a side leveling member connected to both side ends of the center leveling member and disposed to extend in the length direction of the vehicle, wherein an upper surface of the center leveling member and an upper surface of the side leveling member may be disposed to have the same height as an upper surface height of the suspension mounting portion.

A vehicle body joint structure according to an embodiment of the present disclosure may further include: a front support reinforcement connected to a front end of the side leveling member and disposed on an upper surface of the front end of the monocoque platform; and a rear support reinforcement connected to a rear end of the side leveling member and disposed on an upper surface of the rear end of the monocoque platform, and the upper surface of the front support reinforcement and the upper surface of the rear support reinforcement may be disposed to be the same height as the upper surface height of the suspension mounting portion.

A vehicle body joint structure according to an embodiment of the present disclosure may further include a load path dividing reinforcement connected to the rear end of the rear support reinforcement and disposed in a form extended toward the suspension mounting portion.

A vehicle body of the suspension mounting portion may include: a rear side upper member forming an upper surface of the vehicle body; a rear side middle member connected to a bottom surface of the rear side upper member and extended downward; and a rear side lower member connected to an inner surface of the rear side middle member and extended in parallel with the rear side upper member.

The load path dividing reinforcement may be formed in a “U” shape with an upper portion open, and may be coupled to a vehicle body of the suspension mounting portion.

The bottom surface of the rear side upper member may be coupled on the load path dividing reinforcement, the rear side middle member may be coupled to a side portion of the load path dividing reinforcement, and the rear side lower member may be coupled to a lower portion of the load path dividing reinforcement.

A vehicle body joint structure according to an embodiment of the present disclosure may further include: an inside support reinforcement disposed inside the cabin portion to support the cabin portion; and an inside lower connect reinforcement connected with the inside support reinforcement and disposed on the upper surface of the monocoque platform.

The inside lower connect reinforcement may be coupled to the upper surface of the monocoque platform, and the inside support reinforcement may be disposed to be coupled to the upper surface of the inside lower connect reinforcement while covering the same.

The front support reinforcement may be disposed on both sides of the front of the monocoque platform, and a front end of the front support reinforcement may be disposed to support an outer side of the cabin portion.

The side leveling member may be formed in a tunnel shape, formed of a side upper member and a side lower member connected to a lower portion of the side upper member.

The side upper member and the side lower member may be coupled to the front support reinforcement and the rear support reinforcement, respectively, by bolts.

The side upper member may be coupled to the upper surface of the front support reinforcement and the upper surface of the rear support reinforcement respectively by a first bolt, and the side lower member may be coupled to an inner central portion and a side surface of the front support reinforcement and rear support reinforcement, respectively, by a second bolt and a third bold.

The center leveling member may be formed in a tunnel shape, formed of a center upper member and a center lower member connected to a lower portion of the center upper member.

The center lower member may be coupled to the side leveling member by a fourth bolt, and the center upper member and center lower member may be coupled with each other by a fifth bolt.

The suspension may be a coupled torsion beam axle (CTBA).

According to an embodiment of the present disclosure, the leveling member and the support reinforcement may be arranged on the monocoque platform of the vehicle, and thus a step difference between the monocoque platform and the suspension mounting portion can be removed, thereby leveling the special equipment part to facilitate the manufacturing of the special equipment and improve usability by increasing a space in the special equipment part.

In some embodiments, because the leveling may start at a step area between the monocoque platform and the suspension mounting portion and the load path dividing reinforcement may be arranged, a load applied during a rear collision can be distributed such that the standards of rear collision regulations and bumper test regulations can be satisfied.

Furthermore, in some embodiments, due to securing the rigidity of the vehicle body, damage to a battery mounted on the vehicle can be prevented, and safety of an occupant can be improved.

Furthermore, in some embodiments, it may be possible to easily and flexibly adapt to various vehicle models by changing the position and number of the leveling member and the support reinforcement such that they can be applied according to the size and shape of the vehicle.

### BRIEF DESCRIPTION OF THE DRAWINGS

FIG. 1 shows an example of a monocoque body type PBV vehicle for corresponding to existing low-floor construction.

FIG. 2 shows a figure of a vehicle to which a vehicle body joint structure according to an example embodiment of the present disclosure is applied, viewed from a side.

FIG. 3 shows a figure of a vehicle to which a vehicle body joint structure according to an example embodiment of the present disclosure is applied, viewed from top.

FIG. 4 shows a figure of a vehicle to which a vehicle body joint structure according to an example embodiment of the present disclosure is applied, viewed from rear top.

FIG. 5 is an enlarged perspective view of a vehicle body joint structure according to an example embodiment of the present disclosure.

FIG. 6 is a cross-sectional view of FIG. 5, taken along the line A.

FIG. 7 is a cross-sectional view of FIG. 5, taken along the line B.

FIG. 8 is a cross-sectional view of FIG. 5, taken along the line C.

FIG. 9 shows an inner side of a cabin portion of the vehicle body joint structure according to an example embodiment of the present disclosure.

FIG. 10 is a cross-sectional view of a figure in which inside reinforcements shown in FIG. 9 are installed.

FIG. 11 is a diagram illustrating a state in which a support reinforcement is assembled, in an assembly sequence of a vehicle body coupling structure according to an example embodiment of the present disclosure.

FIG. 12 is a diagram illustrating a state in which a side leveling member is being assembled, in an assembly sequence of a vehicle body coupling structure according to an example embodiment of the present disclosure.

FIG. 13 is a diagram illustrating an enlarged view of a state in which the side leveling member is assembled, in the assembly sequence of the vehicle body coupling structure according to an example embodiment of the present disclosure.

FIGS. 14(a), 14(b), and 14(c) are various cross-sectional views illustrating a state in which the side leveling member illustrated in FIG. 13 is coupled with a support reinforcement, according to various example embodiments of the present disclosure.

FIG. 15 is a diagram illustrating a state in which a center leveling member is being assembled, in an assembly sequence of a vehicle body coupling structure according to an example embodiment of the present disclosure.

FIG. 16 is a diagram illustrating a state in which the center leveling member illustrated in FIG. 15 is coupled with a side leveling member, according to an example embodiment of the present disclosure.

FIGS. 17(a) and 17(b) are various cross-sectional views illustrating positions of bolts for coupling the center leveling member illustrated in FIG. 16 to the side leveling member, according to various example embodiments of the present disclosure.

FIG. 18 is a diagram illustrating a state in which the assembly of the vehicle body coupling structure according to an example embodiment of the present disclosure is completed.

FIGS. 19(a) and 19(b) are diagrams comparing a state in which special equipment is mounted after the vehicle body coupling structure according to an example embodiment of the present disclosure is applied with a state of a conventional vehicle body.

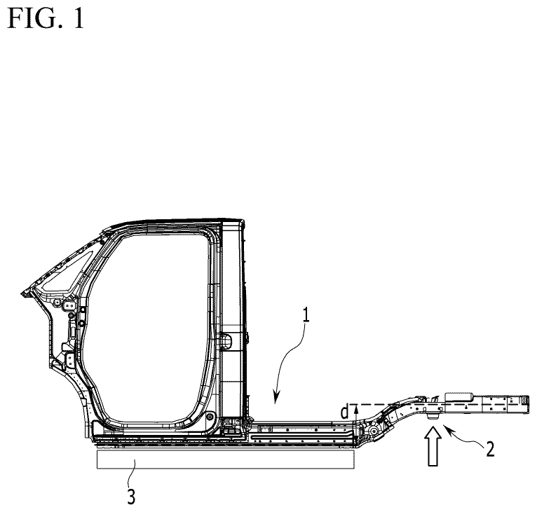

### DETAILED DESCRIPTION OF ILLUSTRATIVE EMBODIMENTS

Next, some example embodiments of the present disclosure will be described in detail with reference to the accompanying drawings such that a person skilled in the art to which the present disclosure pertains can easily carry out an embodiment of the present disclosure. The present disclosure may be embodied in many different forms and is not limited to the embodiments described herein.

In the various example embodiments, constituent elements having a same configuration may be described be representative examples using a same reference numeral.

It is noted that the drawings are schematic and may not be drawn to scale. The relative dimensions and proportions of the parts in the drawings may be shown exaggerated or reduced in size for clarity and convenience in the drawings, and any dimensions are for illustrative purposes for example embodiments and are not necessarily restrictive. Same reference numerals may be used for the same structures, elements, or parts appearing in two or more drawings to indicate similar features. When a part is referred to as being “on” or “over” another part, it can be directly on the other part, or intervening parts may also be present.

The present disclosure specifically illustrates some example embodiments, and various modifications of the illustrations for other embodiments may be expected. Therefore, the present disclosure is not necessarily limited to the specific form of the region shown for the example embodiments, and may include, for example, variations in form due to manufacturing for other embodiments of the present disclosure.

Next, a vehicle body joint structure of a vehicle according to some example embodiments of the present disclosure will be described in detail with reference to the accompanying drawings.

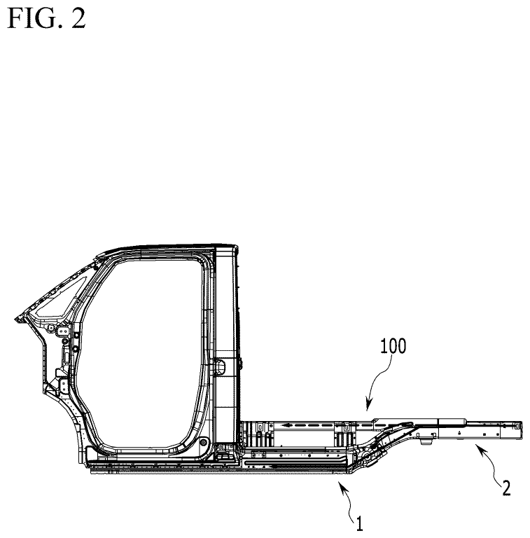

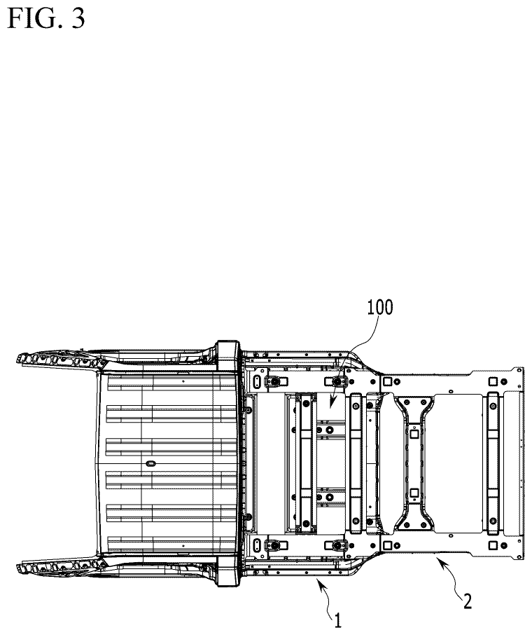

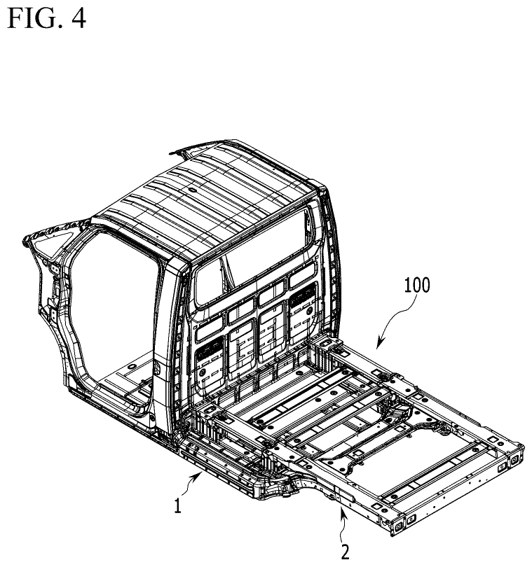

FIG. 2 shows a figure of a vehicle to which a vehicle body joint structure according to an example embodiment of the present disclosure is applied, viewed from a side. FIG. 3 shows a figure of a vehicle to which a vehicle body joint structure according to an example embodiment of the present disclosure is applied, viewed from top. FIG. 4 shows a figure of a vehicle to which a vehicle body joint structure according to an example embodiment of the present disclosure is applied, viewed from rear top.

As shown in FIG. 2 to FIG. 4, in some embodiments, a vehicle body joint structure 100 may be applied to a monocoque body type purpose built vehicle (PBV), and the vehicle body may be formed of a low-floor monocoque platform 1 and a suspension mounting portion 2 formed to extend to the low-floor monocoque platform 1 and to which a suspension is mounted. A cabin portion, which is a space for a passenger, may be formed in a front portion of the monocoque platform 1, and an equipment part for placing a cargo may be formed in a space at the rear of the cabin and at the suspension mounting portion 2.

In some embodiments, the suspension may be a coupled torsion beam axle (CTBA), for example.

In some embodiments, because the monocoque platform 1 is lowered, a step difference is formed between the monocoque platform 1 and the suspension mounting portion 2. The step may be formed in a shape curved from the monocoque platform 1 to the suspension mounting portion 2, and may be a weakness because it may be broken due to rear impact. In order to remove the step difference, in the vehicle body joint structure 100 according to an example embodiment of the present disclosure, a plurality of leveling members 10 and 20 and a plurality of reinforcements 32 and 34 may be provided in an upper portion of the monocoque platform 1 such that upper surfaces of leveling members 10 and 20, upper surfaces of the reinforcements 32 and 34, and an upper surface of the vehicle body of the suspension mounting portion 2 can be formed in a horizontal shape. In some embodiments, a space between the monocoque platform 1 and the suspension mounting portion 2 is formed to be flat, and thus leveling of the special equipment part can be achieved, and also, the load applied to the vehicle body during rear collision can be distributed. For the distribution of the load, in some embodiments, a load path dividing reinforcement 40 in a shape extending from the monocoque platform 1 toward the suspension mounting portion 2 may be further provided.

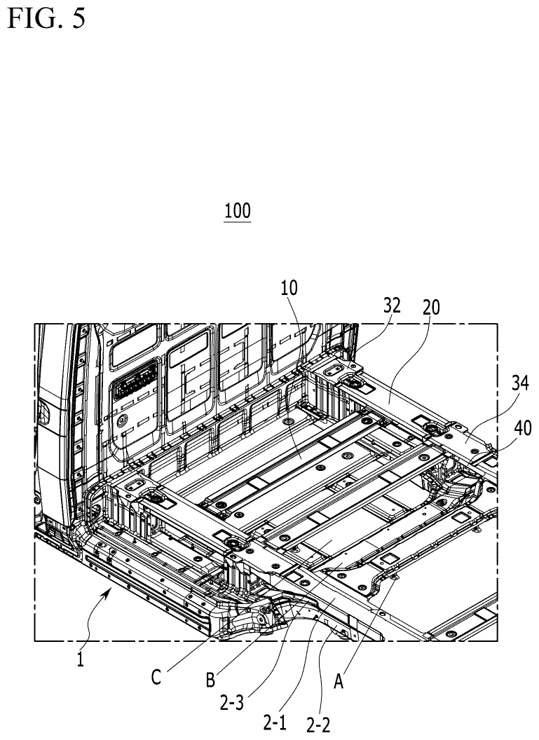

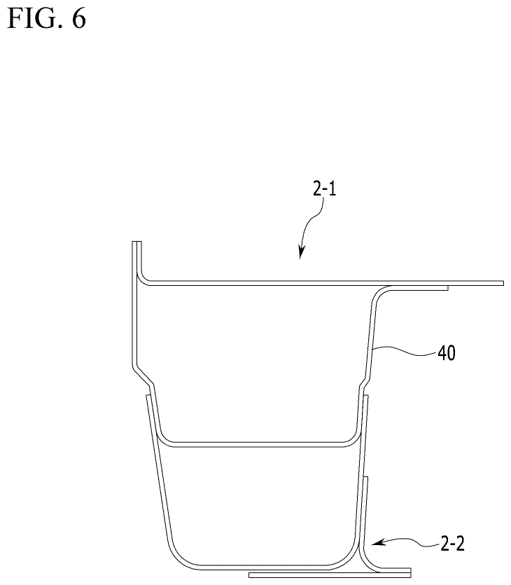

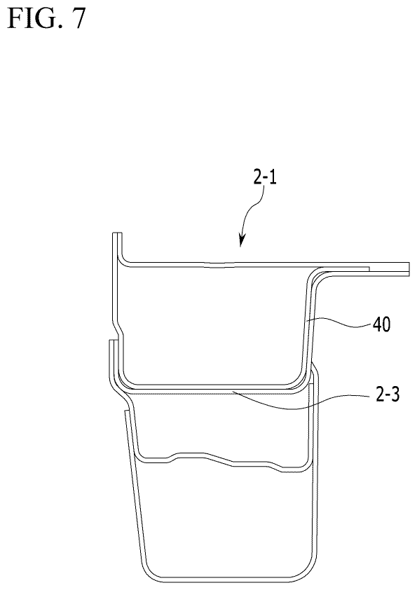

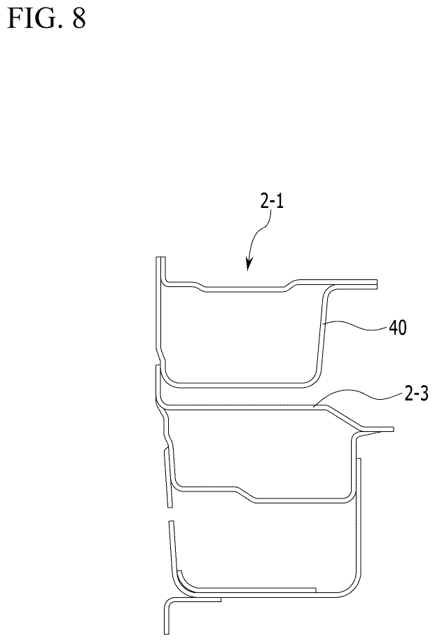

FIG. 5 is an enlarged view of a vehicle body joint structure according to an example embodiment of the present disclosure. FIG. 6 is a cross-sectional view of FIG. 5, taken along the line A. FIG. 7 is a cross-sectional view of FIG. 5, taken along the line B. FIG. 8 is a cross-sectional view of FIG. 5, taken along the line C.

Referring to FIG. 5, the vehicle body joint structure 100 according to an example embodiment of the present disclosure may include a center leveling member 10, a side leveling member 20, a plurality of support reinforcements 32 and 34, and a load path dividing reinforcement 40.

In some embodiments, the center leveling member 10 may be disposed to extend in a direction that is perpendicular to a length direction of the vehicle in an upper central portion of the monocoque platform 1. An upper surface of the center leveling member 10 may be disposed on the upper central portion of the monocoque platform 1 such that the upper surface of the suspension mounting portion 2 have the same height as the upper surface of the vehicle body.

In the present example embodiment illustrated in FIG. 5, an example in which one center leveling member 10 is provided is described, but this is not necessarily restrictive, and one or more center leveling members 10 may be disposed to extend in a direction perpendicular to the length direction of the vehicle in the upper central portion of the monocoque platform 1.

In some embodiments, a side leveling member 20 may be disposed to be connected to lateral ends of the center leveling member 10 at central side portions of the monocoque platform 1, and extended in the length direction of the vehicle. An upper surface of the side leveling member 20 may have the same height as the upper surface of the center leveling member 10 and the upper surface of the vehicle body of the suspension mounting portion 2.

In some embodiments, the plurality of support reinforcements 32 and 34 may be formed of a front support reinforcement 32 and a rear support reinforcement 34. There may be two front support reinforcements 32 on the front upper surface of the monocoque platform 1 and may be connected to the front ends of the side leveling members 20. In some embodiments, there may be two rear support reinforcements 34 on the rear upper surface of the monocoque platform 1 and may be connected to the rear ends of the side leveling members 20. The upper surface of the front support reinforcement 32 and the upper surface of the rear support reinforcement 34 may be arranged to have the same height as the upper surface of the center leveling member 10, the upper surface of the side leveling member 20, and the upper surface of the vehicle body of the suspension mounting portion 2.

In the present example embodiment illustrated in FIG. 5, four support reinforcements 32 and 34 are provided, but the present disclosure is not necessarily limited thereto, and more than four support reinforcements 32 and 34 may be arranged on the upper portion of the monocoque platform 1 for example.

In some embodiments, the center leveling member 10, the side leveling members 20, and the support reinforcements 32 and 34 may be arranged on the upper portion of the monocoque platform 1, and the upper surfaces of them may be arranged to have the same height as the upper surface of the vehicle body of the suspension mounting portion 2, thereby achieving leveling of the special equipment part.

In some embodiments, the load path dividing reinforcement 40 may be connected to the rear end of the rear support reinforcement 34, and may be disposed in a form extending toward the suspension mounting portion 2 from the monocoque platform 1. The load path dividing reinforcement 40 may be disposed below the upper surface (a rear side upper member 2-1) of the vehicle body of the suspension mounting portion 2. In some embodiments, the load path dividing reinforcement 40 may improve rigidity of a connection portion of the monocoque platform 1 and the suspension mounting portion 2, and distribute impact load transferred to the monocoque platform 1 from the rear of the vehicle body.

As shown in FIG. 6 to FIG. 8, in some embodiments, the load path dividing reinforcement 40 may be formed in a “U” shape with an upper portion open, and may be coupled to the vehicle body of the suspension mounting portion 2. In some embodiments, the vehicle body of the suspension mounting portion 2 may be configured with a rear side upper member 2-1 that forms the upper surface of the vehicle body of the suspension mounting portion 2, a rear side middle member 2-2 connected to a bottom surface of the rear side upper member 2-1 and extending toward a lower portion, and a rear side lower member 2-3 connected to an internal side of the rear side middle member 2-2 and extending in parallel with the rear side upper member 2-1.

In some embodiments, an upper portion of the load path dividing reinforcement 40 may be coupled to a bottom surface of the rear side upper member 2-1. The upper portion of the load path dividing reinforcement 40 may be formed in a form extending toward the inside of the vehicle body, and the extended portion may be coupled to the lower surface of the rear side upper member 2-1.

In some embodiments, the rear side middle member 2-2 may be coupled to a side portion of the load path dividing reinforcement 40. The rear side middle member 2-2 may be coupled to the side portion of the load path dividing reinforcement 40 in the form of surrounding the side portion of the load path dividing reinforcement 40.

In some embodiments, the rear side lower member 2-3 may be coupled to a lower portion of the load path dividing reinforcement 40 (see, e.g., FIG. 7). The rear side lower member 2-3 may not have an even height along the length direction of the vehicle body of the suspension mounting portion 2, and thus the lower portion of the load path dividing reinforcement 40 may contact the rear side lower member 2-3 at line “B” of FIG. 5 and may not contact at line “C” in FIG. 5, for example.

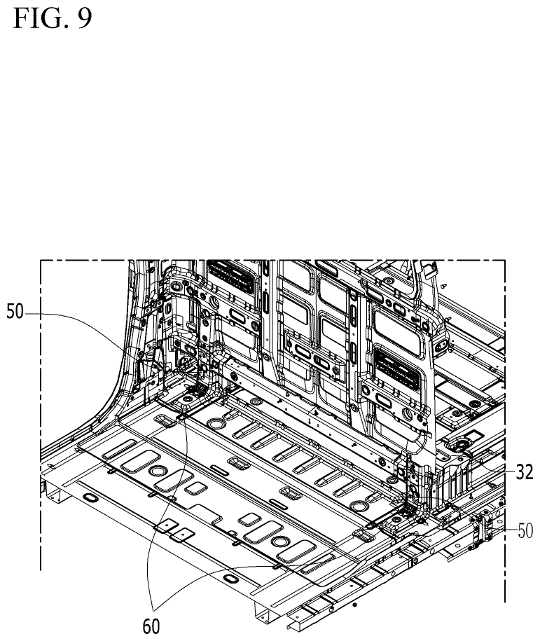

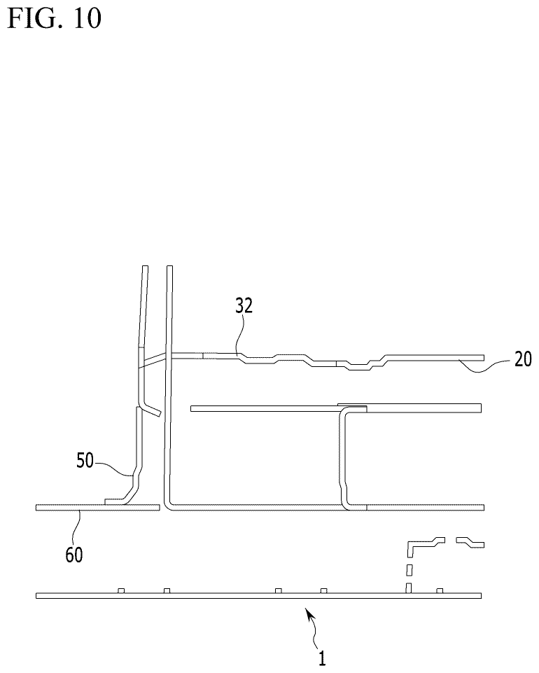

FIG. 9 shows an inner side of a cabin portion of a vehicle body joint structure according to an example embodiment of the present disclosure. FIG. 10 is a cross-sectional view of a figure in which inside reinforcements shown in FIG. 9 are installed.

Referring to FIG. 9, the vehicle body joint structure 100 according to an example embodiment of the present disclosure may further include an inside support reinforcement 50 and an inside lower connect reinforcement 60.

In some embodiments, the inside support reinforcement 50 may be disposed to support the cabin portion in the inner side of the cabin portion. The inside support reinforcement 50 may be formed in the form of a rectangle extending in a direction parallel with the direction vertical to the upper surface of the monocoque platform 1.

In some embodiments, the inside lower connect reinforcement 60 may be connected with the inside support reinforcement 50, and may be disposed on the upper surface of the monocoque platform 1. In some embodiments, the inside lower connect reinforcement 60 may be coupled to the upper surface of the monocoque platform 1, and the inside support reinforcement 50 may be coupled to the upper surface of the inside lower connect reinforcement 60 while covering the same.

As shown in FIG. 10, in some embodiments, the front support reinforcement 32 may be connected to the outer side of the cabin portion and the inside support reinforcement 50 may be connected to the inner side of the cabin portion while interposing the cabin portion therebetween. The front support reinforcement 32 may be disposed such that the front end may support the outer side of the cabin portion.

As such, in some embodiments, a structure in which the reinforcements 50 and 60 support at both sides of the cabin portion may be formed and a structure in which the inside support reinforcement 50 and the inside lower connect reinforcement 60 are disposed inside the cabin portion may be formed, and thus the rigidity of the cabin portion can be improved and the impact load transferred to the cabin portion from rear side collision of the vehicle body can be dispersed.

In the present example embodiment illustrated in FIGS. 9 and 10, an example in which one inside support reinforcement 50 and one inside lower connect reinforcement 60 are respectively provided has been described, but the present disclosure is not necessarily limited thereto, and it may be configured by a combination of one or more inside support reinforcements 50 and inside lower connect reinforcements 60.

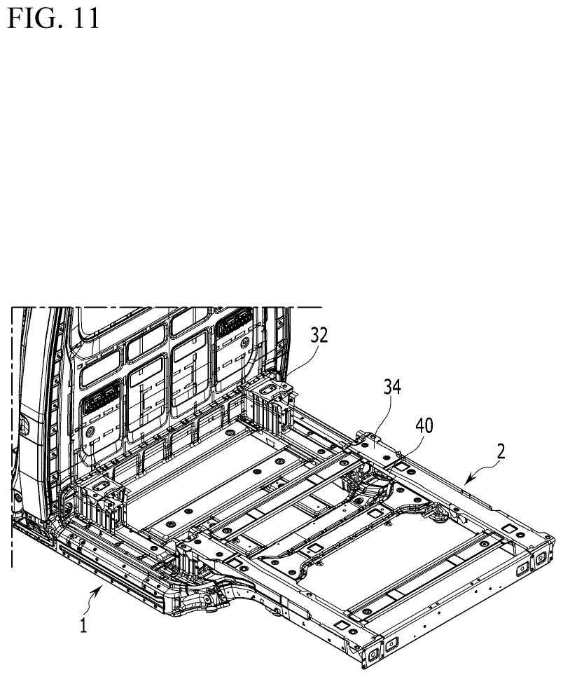

FIG. 11 is a diagram illustrating a state in which a support reinforcement is assembled, in an assembly sequence of a vehicle body coupling structure according to an example embodiment of the present disclosure.

As shown in FIG. 11, in some embodiments, the front support reinforcement 32 may be disposed on both front sides of the monocoque platform 1, and a front end of the front support reinforcement 32 may be disposed to support an outer side of the cabin portion.

In some embodiments, rear support reinforcement 34 may be disposed on both rear sides of the monocoque platform 1, and a rear end of the rear support reinforcement 34 may be connected to the load path dividing reinforcement 40.

In some embodiments, the load path dividing reinforcement 40 may be installed on the vehicle body of the suspension mounting portion 2, and the front support reinforcement 32 and the rear support reinforcement 34 may be assembled on an upper surface of the monocoque platform 1.

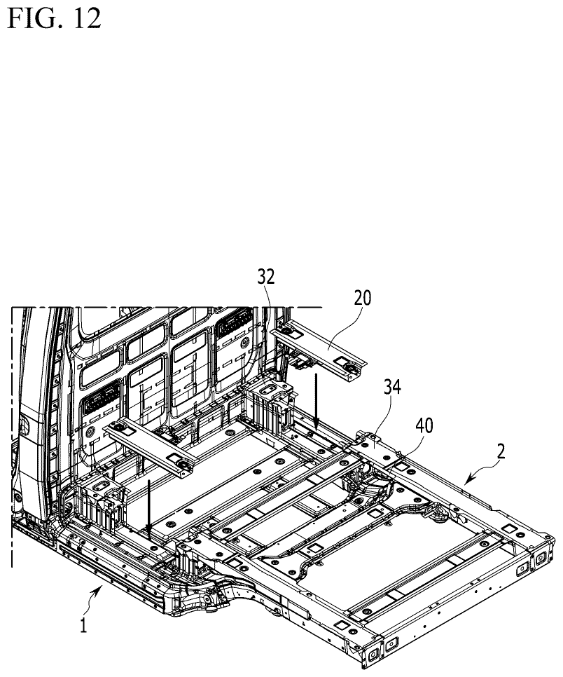

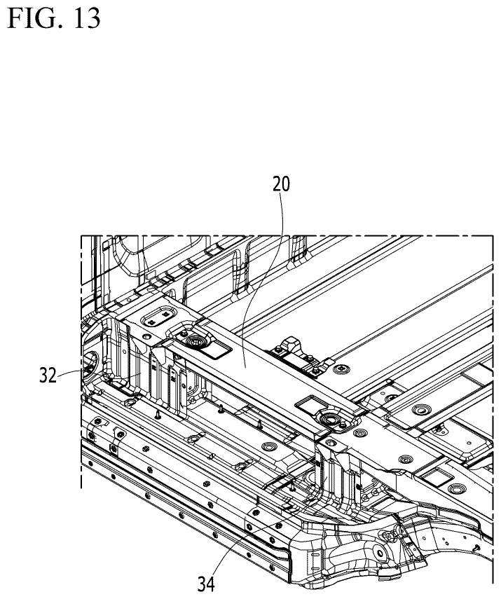

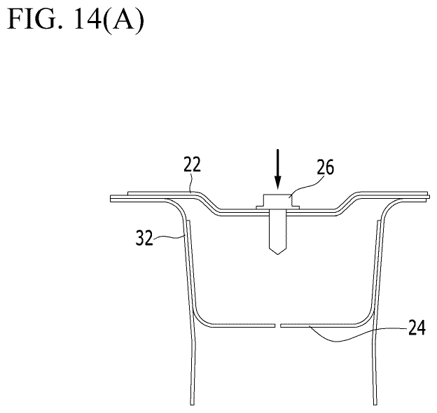

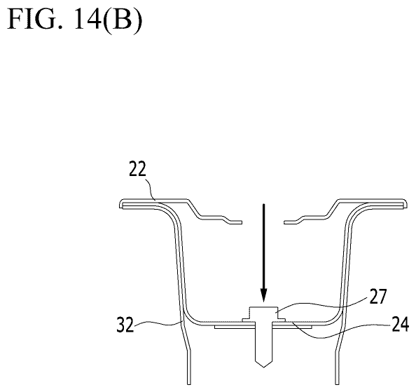

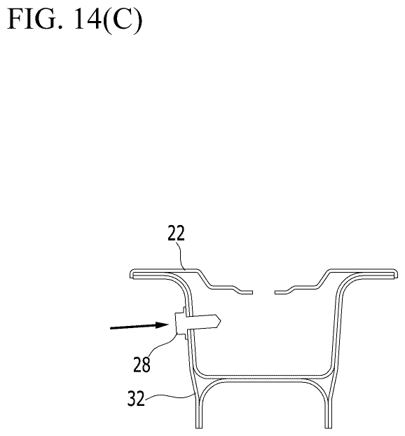

FIG. 12 is a diagram illustrating a state in which a side leveling member is being assembled, in an assembly sequence of a vehicle body coupling structure according to an example embodiment of the present disclosure. FIG. 13 is a diagram illustrating an enlarged view of a state in which the side leveling member is assembled, in the assembly sequence of the vehicle body coupling structure according to an example embodiment of the present disclosure. FIG. 14(a), 14(b), and 14(c) are various cross-sectional views illustrating a state in which the side leveling member illustrated in FIG. 13 is coupled with a support reinforcement, according to various example embodiments of the present disclosure.

As shown in FIG. 12 and FIG. 13, in some embodiments, the side leveling member 20 may be coupled between a rear end of the front support reinforcement 32 and a front end of the rear support reinforcement 34.

In some embodiments, the side leveling member 20 may be formed in a tunnel shape composed of a side upper member 22 and a side lower member 24 connected to a lower portion of the side upper member 22. As shown in FIG. 14(a), 14(b), and 14(c), in some embodiments, the side upper member 22 and the side lower member 24 may be coupled by bolts with the front support reinforcement 32 and the rear support reinforcement 34 in various ways. The side upper member 22 may be coupled to upper surfaces of the front support reinforcement 32 and rear support reinforcement 34 respectively by a first bolt 26, as illustrated in FIG. 14(a). In some embodiments, the side lower member 24 may be coupled to an inner central portion and a side surface of the front support reinforcement 32 and the rear support reinforcement 34, respectively, by a second bolt 27 and a third bolt 28 (as illustrated in FIG. 14(b) and 14(c)).

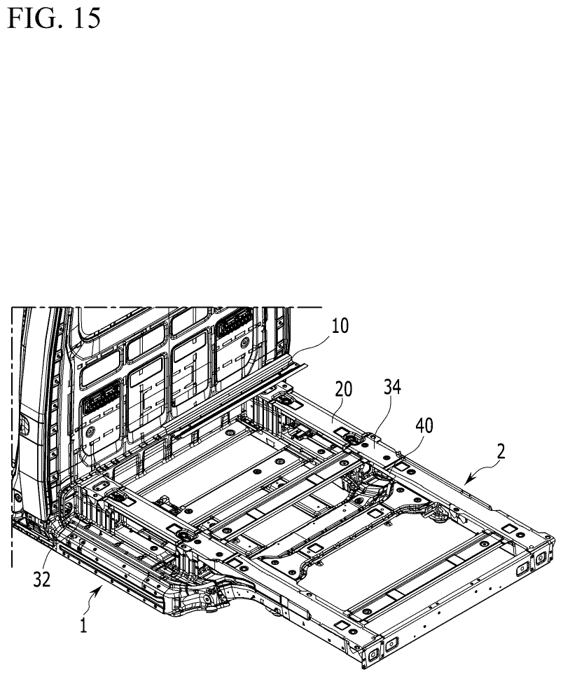

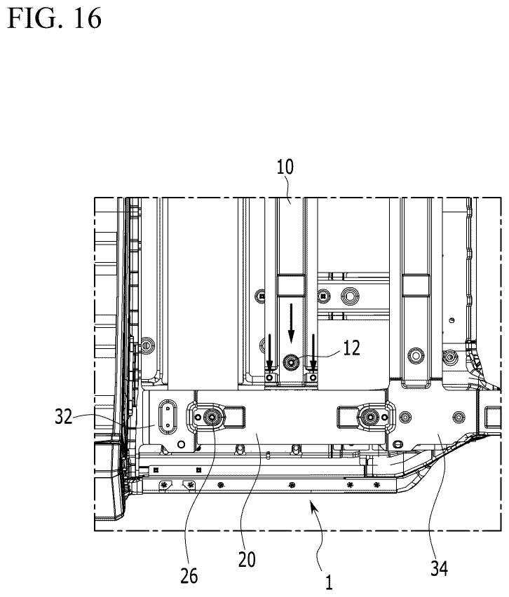

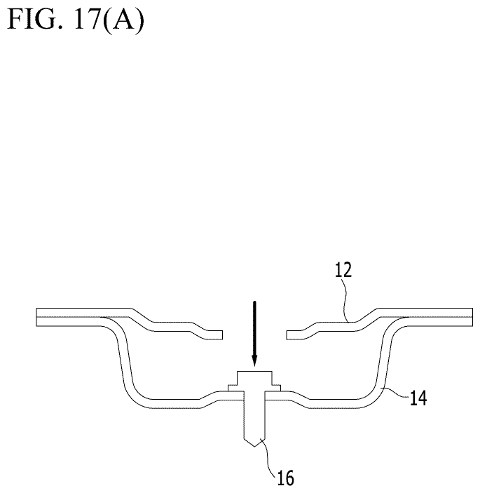

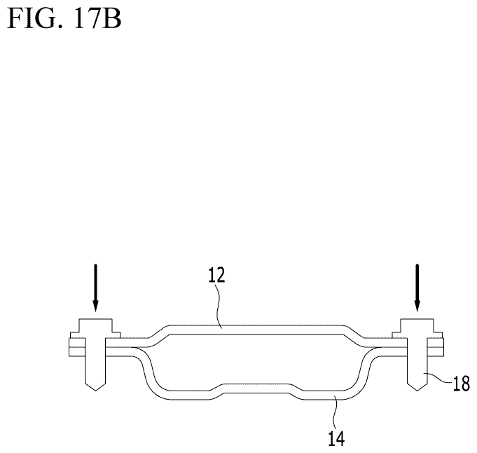

FIG. 15 is a diagram illustrating a state in which a center leveling member is being assembled, in an assembly sequence of a vehicle body coupling structure according to an example embodiment of the present disclosure. FIG. 16 is a diagram illustrating a state in which the center leveling member illustrated in FIG. 15 is coupled with a side leveling member, and FIG. 17(a) and 17(b) are various cross-sectional views illustrating positions of bolts for coupling the center leveling member illustrated in FIG. 16 to the side leveling member, according to various example embodiments of the present disclosure.

As shown in FIG. 15 and FIG. 16, in some embodiments, the center leveling member 10 may be coupled to the side leveling member 20 assembled on both sides of the vehicle body. A seating portion protruding toward an inner side of the vehicle body may be formed at a central portion of the side leveling member 20, and both ends pf the center leveling member 10 may be seated on and coupled to the seating portion.

As shown in FIG. 17(a) and 17(b), in some embodiments, the center leveling member 10 may be formed in a tunnel shape composed of a center upper member 12 and a center lower member 14 connected to a lower portion of the center upper member 12. As illustrated in FIG. 17(a), in some embodiments, the center lower member 14 may have a “U” shape with an open top, and a lower surface of the center lower member 14 may be coupled to the side leveling member 20 by a fourth bolt 16. As illustrated in FIG. 17(b), in some embodiments, the center upper member 12 and the center lower member 14 may be coupled to each other at an edge portion by a fifth bolt 18.

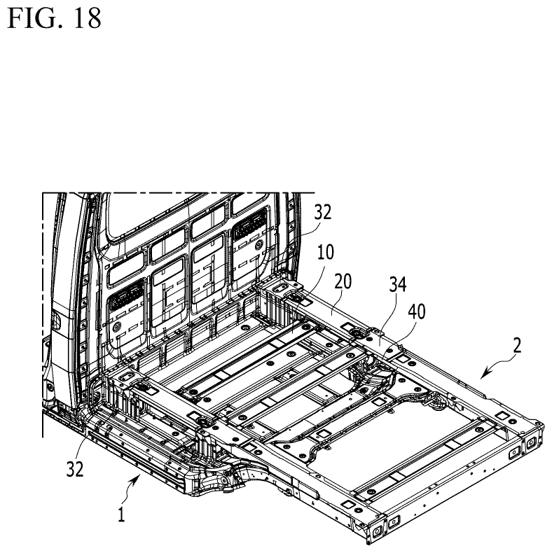

FIG. 18 is a diagram illustrating a state in which the assembly of the vehicle body coupling structure according to an example embodiment of the present disclosure is completed.

As shown in FIG. 18, in some embodiments, when the load path dividing reinforcement 40 is installed on the vehicle body of the suspension mounting portion 2 and the assembly of the center leveling member 10, the side leveling member 20, and the support reinforcements 32 and 34 is completed, the upper surface of the center leveling member 10, the upper surface of the side leveling member 20, the upper surface of the front support reinforcement 32, and the upper surface of the rear support reinforcement 34 become the same height as the upper surface of the suspension mounting portion 2. That is, in some embodiments, the special equipment part of the vehicle becomes flat. In some embodiments, the structure of the flattened vehicle body can improve the rigidity of the vehicle body by eliminating the step difference between the monocoque platform 1 and the suspension mounting portion 2.

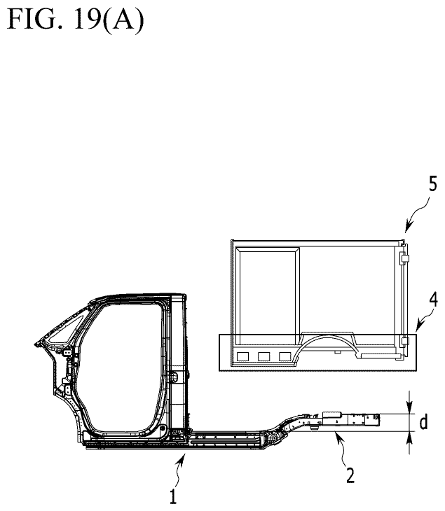

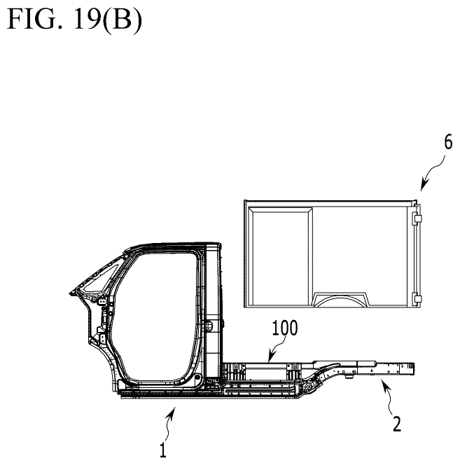

FIG. 19(a) and 19(b) are diagrams comparing a state in which special equipment is mounted after the vehicle body coupling structure according to an example embodiment of the present disclosure is applied (see, e.g., FIG. 19(b)) with a state of a conventional vehicle body(see, e.g., FIG. 19(a)).

As shown in FIG. 19(a), when a step difference d exists between the monocoque platform 1 and the suspension mounting portion 2 of the vehicle, the bottom surface 4 of the special equipment 5 mounted on the special equipment part needs to be manufactured to correspond to the step difference d. This causes the manufacturing of the special equipment 5 to be difficult and narrows an internal space of the special equipment 5.

In contrast, as illustrated in FIG. 19(b), due to the leveling of the special equipment part realized by the vehicle body joint structure 100 according to an example embodiment of the present disclosure, a lower surface of the special equipment 6 can be manufactured to be flat, and this may increase the internal space of the special equipment 6, thereby improving usability.

As described above, according to an example embodiment of the present disclosure, by disposing leveling members and support reinforcements on a monocoque platform of a vehicle, the step difference between the monocoque platform and the suspension mounting portion may be eliminated, thereby facilitating the manufacturing of special equipment due to the leveling of the special equipment part, and improving usability due to the increase in space within the special equipment.

In some embodiments, the leveling starts at a step portion between the monocoque platform and the suspension mounting portion, and by disposing the load path dividing reinforcement, the load applied during a rear collision can be distributed, thereby satisfying the criteria of rear collision regulations and bumper test regulations.

In some embodiments, by securing the rigidity of the vehicle body, damage to a battery mounted on the vehicle can be prevented, and the safety of occupants can be improved.

In some embodiments, it is possible to easily and flexibly adapt to multi-specification vehicle models by changing the positions and number of the leveling members and the support reinforcements such that they can be applied according to the size and shape of the vehicle.

Although some example embodiments of the present disclosure have been described above, the present disclosure is not necessarily limited to the above-described example embodiments, and includes modifications and combinations for other embodiments within scopes recognized as equivalent that can be made by a person having ordinary skill in the technical field to which the present disclosure pertains from the example embodiments of the present disclosure, or as defined by the appended claims and equivalents thereof.

What is claimed is:

1. A vehicle body joint structure of a vehicle, wherein the vehicle comprises a monocoque platform including a cabin portion, and a suspension mounting portion having a step difference with respect to the monocoque platform, the suspension mounting portion configured to mount a suspension on the suspension mounting portion, the vehicle body joint structure comprising:
a center leveling member disposed to extend in a width direction of the vehicle in an upper central portion of the monocoque platform; and
a side leveling member connected to a side end of the center leveling member and disposed to extend in a length direction of the vehicle,
wherein an upper surface of the center leveling member and an upper surface of the side leveling member are disposed to have the same height as an upper surface height of the suspension mounting portion.

2. The vehicle body joint structure of claim 1, further comprising:
a front support reinforcement connected to a front end of the side leveling member and disposed on an upper surface of the monocoque platform; and
a rear support reinforcement connected to a rear end of the side leveling member and disposed on the upper surface of the monocoque platform,
wherein an upper surface of the front support reinforcement and an upper surface of the rear support reinforcement are disposed to be the same height as the upper surface height of the suspension mounting portion.

3. The vehicle body joint structure of claim 2, further comprising a load path dividing reinforcement connected to the rear end of the rear support reinforcement and disposed to extend toward the suspension mounting portion.

4. The vehicle body joint structure of claim 1, wherein the suspension mounting portion comprises:
a rear side upper member;
a rear side middle member connected to a bottom surface of the rear side upper member and extended downward; and
a rear side lower member connected to an inner surface of the rear side middle member and extended in parallel with the rear side upper member.

5. The vehicle body joint structure of claim 3, wherein the load path dividing reinforcement includes a “U” shape with an upper portion open, and is coupled to the suspension mounting portion.

6. The vehicle body joint structure of claim 5, wherein the suspension mounting portion comprises:
a rear side upper member;
a rear side middle member connected to a bottom surface of the rear side upper member and extended downward; and
a rear side lower member connected to an inner surface of the rear side middle member and extended in parallel with the rear side upper member,
wherein the bottom surface of the rear side upper member is coupled on the load path dividing reinforcement,
wherein the rear side middle member is coupled to a side portion of the load path dividing reinforcement, and
wherein the rear side lower member is coupled to a lower portion of the load path dividing reinforcement.

7. The vehicle body joint structure of claim 1, further comprising:
an inside support reinforcement disposed inside the cabin portion and configured to support the cabin portion; and
an inside lower connect reinforcement connected with the inside support reinforcement and disposed on the upper surface of the monocoque platform.

8. The vehicle body joint structure of claim 7, wherein the inside lower connect reinforcement is coupled to the upper surface of the monocoque platform, and
wherein the inside support reinforcement is disposed to be coupled to an upper surface of the inside lower connect reinforcement and covering at least part of the inside lower connect reinforcement.

9. The vehicle body joint structure of claim 2, wherein a front end of the front support reinforcement is disposed to support an outer side of the cabin portion.

10. The vehicle body joint structure of claim 9, wherein the side leveling member includes a tunnel shape comprising a side upper member and a side lower member connected to a lower portion of the side upper member.

11. The vehicle body joint structure of claim 10, wherein the side upper member and the side lower member are coupled to the front support reinforcement and the rear support reinforcement, respectively, by bolts.

12. The vehicle body joint structure of claim 11, wherein the side upper member is coupled to the upper surface of the front support reinforcement and the upper surface of the rear support reinforcement respectively by a first bolt, and
wherein the side lower member is coupled to an inner central portion and a side surface of the front support reinforcement and the rear support reinforcement respectively by a second bolt and a third bolt.

13. The vehicle body joint structure of claim 1, wherein the center leveling member includes a tunnel shape comprising a center upper member and a center lower member connected to a lower portion of the center upper member.

14. The vehicle body joint structure of claim 13, wherein the center lower member is coupled to the side leveling member by a first bolt, and
wherein the center upper member and the center lower member are coupled with each other by a second bolt.

15. The vehicle body joint structure of claim 1, wherein the suspension mounting portion is configured for mounting the suspension including a coupled torsion beam axle (CTBA).

16. A vehicle comprising:
a monocoque platform having an upper surface at a first height;
a cabin portion of a vehicle body disposed on and coupled to the upper surface of the monocoque platform;
a suspension mounting portion having an upper surface at a second height higher than the first height such that there is a step difference between the first height and the second height, wherein the suspension mounting portion is configured to have a suspension coupled to the suspension mounting portion; and
a vehicle body joint structure comprising:
a center leveling member disposed to extend in a width direction of the vehicle above the monocoque platform with an upper surface at the second height; and
a side leveling member connected to a side end of the center leveling member and disposed to extend in a length direction of the vehicle with an upper surface at the second height,
wherein the upper surface of the center leveling member, the upper surface of the side leveling member, and the upper surface of the suspension mounting portion are horizontally aligned.

17. The vehicle of claim 16, further comprising a cargo portion of the vehicle body having a flat bottom disposed on the upper surface of the center leveling member, the upper surface of the side leveling member, and the upper surface of the suspension mounting portion.

18. The vehicle of claim 16, wherein the vehicle body joint structure further comprises:
a front support reinforcement connected to a front end of the side leveling member and disposed on the upper surface of the monocoque platform, wherein an upper surface of the front support reinforcement is at the second height; and
a rear support reinforcement connected to a rear end of the side leveling member and disposed on the upper surface of the monocoque platform, wherein an upper surface of the front support reinforcement is at the second height,
wherein the upper surface of the front support reinforcement, the upper surface of the rear support reinforcement, the upper surface of the center leveling member, the upper surface of the side leveling member, and the upper surface of the suspension mounting portion are horizontally aligned.

19. The vehicle of claim 18, further comprising a cargo portion of the vehicle body having a flat bottom disposed on the upper surface of the front support reinforcement, the upper surface of the rear support reinforcement, the upper surface of the center leveling member, the upper surface of the side leveling member, and the upper surface of the suspension mounting portion.

20. A vehicle comprising:
a monocoque platform having an upper surface at a first height;
a cabin portion of a vehicle body disposed on and coupled to the upper surface of the monocoque platform;
a suspension mounting portion having an upper surface at a second height higher than the first height such that there is a step difference between the first height and the second height, wherein the suspension mounting portion is configured to have a suspension coupled to the suspension mounting portion;
a vehicle body joint structure comprising:
a center leveling member disposed to extend in a width direction of the vehicle above the monocoque platform with an upper surface at the second height; and
a side leveling member connected to a side end of the center leveling member and disposed to extend in a length direction of the vehicle with an upper surface at the second height,
a front support reinforcement connected to a front end of the side leveling member and disposed on the upper surface of the monocoque platform, wherein an upper surface of the front support reinforcement is at the second height, and
a rear support reinforcement connected to a rear end of the side leveling member and disposed on the upper surface of the monocoque platform, wherein an upper surface of the front support reinforcement is at the second height,
wherein the upper surface of the front support reinforcement, the upper surface of the rear support reinforcement, the upper surface of the center leveling member, the upper surface of the side leveling member, and the upper surface of the suspension mounting portion are horizontally aligned; and
a cargo portion of the vehicle body having a flat bottom disposed on the upper surface of the front support reinforcement, the upper surface of the rear support reinforcement, the upper surface of the center leveling member, the upper surface of the side leveling member, and the upper surface of the suspension mounting portion.
